(19) United States
(12) Patent Application Publication
(10) Pub. No.: US 2013/0145266 A1
(43) Pub. Date: Jun. 6, 2013

(54) GRAPHICAL USER INTERFACE HAVING INTERACTIVE STACKS OF IMAGES CORRESPONDING TO DIGITAL ASSETS

(71) Applicants: Louie D. Mantia, San Francisco, CA (US); Joe R. Howard, San Jose, CA (US)

(72) Inventors: Louie D. Mantia, San Francisco, CA (US); Joe R. Howard, San Jose, CA (US)

(21) Appl. No.: 13/310,674

(22) Filed: Dec. 2, 2011

(51) Int. Cl. G06F 3/01

(52) U.S. Cl. 715/716

(57) ABSTRACT

Improved techniques, user interfaces and systems for presenting, accessing and using digital assets are disclosed. The digital assets can be stored in a media library and the techniques, user interfaces and systems can facilitate efficient and visual access to the digital assets. One aspect of certain embodiments pertains to presentation on a display device of a plurality of stacks of images. Another aspect of certain embodiments pertains to presentation on a display device of a plurality of lists of images. The images in the stacks of images or lists of images can represent a set of digital assets, such as a set of digital media assets. The set of digital assets associated with a stack or list can be identified by operation of the electronic device in accordance with certain criteria.

### BACKGROUND OF THE INVENTION

Personal computing devices, such as laptop computers, tablet computers, personal digital assistants, smart phones, etc., often include the capability to store, browse, search and play digital assets, such as digital media assets. A computer program, such as a media management program, operating on a personal computing device can provide graphical user interfaces that allow a user to store, browse, search, organize and play digital assets. The graphical user interface can include text or images to assist a user in accessing, managing or playing the desired digital assets. Despite the effectiveness of existing graphical user interfaces, there remains a need for improved approaches to access, manage and/or play digital assets.

### SUMMARY

Improved techniques, user interfaces and systems for presenting, accessing and using digital assets are disclosed. The digital assets can be stored in a media library and the techniques, user interfaces and systems can facilitate efficient and visual access to the digital assets. The improved techniques, user interfaces and systems can be used on or by an electronic device, such as a personal computing device. The digital assets can include media assets and/or non-media assets.

One aspect of certain embodiments pertains to presentation on a display device of a plurality of stacks of images. The images in the stacks of images can represent a set of digital assets, such as a set of digital media assets. The set of digital assets associated with a stack can be identified by operation of the electronic device in accordance with certain criteria. The criteria utilized can depend on the type of stack to be provided. By presenting a plurality of stacks of images, with each representing a different type of stack, a user is able to visually navigate a substantial digital library in an efficient and intuitive manner. For example, after the stacks of images are presented, the user can interact with the stacks to locate or select a particular one or more digital assets to be played/executed.

Another aspect of certain embodiments pertains to presentation on a display device of a plurality of lists of images. The images in the lists of images can represent a set of digital assets, such as a set of digital media assets. The set of digital assets associated with a list can be identified by operation of the electronic device in accordance with certain criteria. The criteria utilized can depend on the type of list to be provided. By presenting a plurality of lists of images, with each representing a different type of list, a user is able to visually navigate a substantial digital library in an efficient and intuitive manner. For example, after the lists of images are presented, the user can interact with the stacks to locate or select a particular one or more digital assets to be played/executed.

Another aspect of certain embodiments pertains to presentation on a display device of a plurality of stacks of images as well as a plurality of lists of images.

The invention can be implemented in numerous ways, including as a method, system, device, apparatus (including computer readable medium and graphical user interface). Several embodiments of the invention are discussed below.

As a method for discovering digital media assets from a media library storing a plurality of digital media assets, one embodiment can, for example, include at least: determining, using at least one computing device, an image stack type for each of a plurality of image stacks to be provided in a stack region of a graphical user interface presented on a display device associated with the computing device; determining, using the at least one computing device, a set of digital media assets for each of the image stacks based on the corresponding image stack type, the digital media assets in each of the sets of digital media assets being selected from the digital media assets in the media library; and displaying the graphical user interface including the image stacks on the display device.

As a non-transitory computer readable storage medium including at least computer program code for discovering digital media assets from a media library storing a plurality of digital media assets, one embodiment can, for example, includes at least: computer program code for determining, using at least one computing device, an image stack type for each of a plurality of image stacks to be provided in a stack region of a graphical user interface presented on a display device associated with the computing device; computer program code for determining, using the at least one computing device, a set of digital media assets for each of the image stacks based on the corresponding image stack type, the digital media assets in each of the sets of digital media assets being selected from the digital media assets in the media library; and computer program code for displaying the graphical user interface including the image stacks on the display device.

As a graphical user interface for display of a display device associated with a computing device, one embodiment of the graphical user interface includes at least at least a stack region displayed on the display device. The stack region includes a plurality of image stacks. Each of the image stacks can include a set of image representations for each of a plurality of digital media assets, and each of the digital media assets associated with each of the image stacks can be selected from a media library resident on the computing device based on a corresponding image stack type. In addition, each of the images stacks can be displayed on the display device in a stacked arrangement wherein a top one of the images in each of the image stacks is visually displayed substantially over each of the other of the images in the image stack. Each of the stacks can also be user-interactive such that a user input over or proximate to the stack permits a user to transition the images in the image stack such that a different one of the images becomes the top one of the images.

Various aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a flow diagram of an image stack presentation method according to one embodiment.

FIG. 2 is an illustration of a graphical user interface according to one embodiment.

FIG. 3 is a flow diagram of an image stack and list presentation method according to one embodiment.

FIG. 4 is an illustration of a graphical user interface according to another embodiment.

FIG. 5 is a block diagram of a computing apparatus according to one embodiment.

FIG. 6 is a flow diagram of a top collections process according to one embodiment.

FIG. 7 is a flow diagram of a top artists process according to one embodiment.

FIG. 8 is a flow diagram of a top genres process according to one embodiment.

FIG. 9 is an illustration of a graphical user interface according to another embodiment.

FIGS. 10A-10C illustrate navigation and utilization of an exemplary image stack according to one embodiment.

FIG. 11 is an illustration of a graphical user interface according to another embodiment.

FIG. 12 is an illustration of a stack region according to an alternative embodiment.

### DETAILED DESCRIPTION OF EMBODIMENTS OF THE INVENTION

Improved techniques, user interfaces and systems for presenting, accessing and using digital assets are disclosed. The digital assets can be stored in a media library and the techniques, user interfaces and systems can facilitate efficient and visual access to the digital assets. The improved techniques, user interfaces and systems can be used on or by an electronic device, such as a personal computing device. The digital assets can include media assets and/or non-media assets.

One aspect of certain embodiments pertains to presentation on a display device of a plurality of stacks of images. The images in the stacks of images can represent a set of digital assets, such as a set of digital media assets. The set of digital assets associated with a stack can be identified by operation of the electronic device in accordance with certain criteria. The criteria utilized can depend on the type of stack to be provided. By presenting a plurality of stacks of images, with each representing a different type of stack, a user is able to visually navigate a substantial digital library in an efficient and intuitive manner. For example, after the stacks of images are presented, the user can interact with the stacks to locate or select a particular one or more digital assets to be played/executed.

Another aspect of certain embodiments pertains to presentation on a display device of a plurality of lists of images. The images in the lists of images can represent a set of digital assets, such as a set of digital media assets. The set of digital assets associated with a list can be identified by operation of the electronic device in accordance with certain criteria. The criteria utilized can depend on the type of list to be provided. By presenting a plurality of lists of images, with each representing a different type of list, a user is able to visually navigate a substantial digital library in an efficient and intuitive manner. For example, after the lists of images are presented, the user can interact with the stacks to locate or select a particular one or more digital assets to be played/executed.

Another aspect of certain embodiments pertains to presentation on a display device of a plurality of stacks of images as well as a plurality of lists of images.

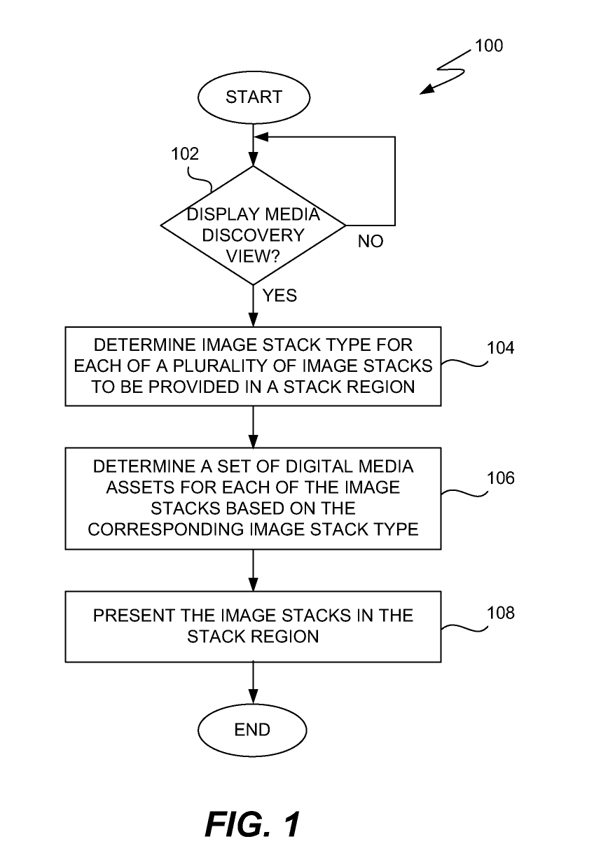

FIG. 1 is a flow diagram of an image stack presentation method 100 according to one embodiment. The image stack presentation method 100 can be performed by a computing device, such as a personal computing device.

The image stack presentation method 100 can begin with a decision 102 that can determine whether a media discovery view is to be displayed. Here, the computing device typically has a display device associated therewith, and the media discovery view can be associated with a graphical user interface that can be presented on the display device. The decision 102 determines whether the media discovery view is to be displayed. When the decision 102 determines that the media discovery view is not to be displayed at this time, the decision 102 can cause the image stack presentation method 100 to await the need to display the media discovery view.

Alternatively, when the decision 102 determines that the media discovery view should be displayed, an image stack type can be determined 104 for each of a plurality of image stacks to be provided in a stack region of the media discovery view. Next, a set of digital media assets for each of the image stacks can be determined 106 based on the corresponding image stack type. In other words, depending upon the particular image stack type, the digital media assets to be provided within a corresponding image stack will differ. Examples of various image stack types are discussed in more detail below. After the set of digital media assets for each of the image stacks has been determined 106, the image stacks can be presented 108 in the stack region of the media discovery view. Following the presentation 108 of the image stacks, the image stack presentation method 100 is complete and can end.

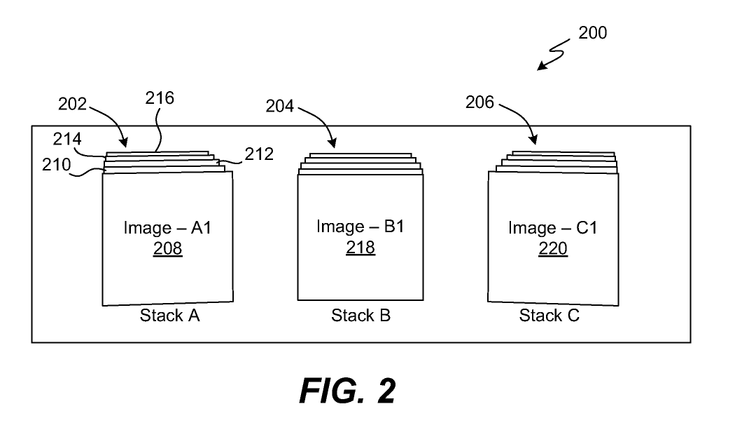

FIG. 2 is an illustration of a graphical user interface 200 according to one embodiment. The graphical user interface 200 can include a plurality of image stacks. As illustrated in FIG. 2, the graphical user interface 200 can include image stack A 202, image stack B 204 and image stack C 206. Each of these image stacks 202, 204 and 206 contain a plurality of associated digital media assets which can each be presented in the graphical user interface 200 by a graphical depiction. With respect to the image stack A 202, graphical depictions for each of its associated digital media assets can be arranged in a stack configuration. For example, as shown in FIG. 2, image A1 208 is the graphical depiction for the digital media asset presently at the top of the image stack A 202. The next image in the stack configuration of the image stack A 202 is image A2 210 which (due to the stacked arrangement) is substantially obscured by the image A1 208. The next image in the stack configuration of the image stack A 202 is image A3 212 which (due to the stacked arrangement) is substantially obscured by the image A1 208 and the image A2 210. The next image in the stack configuration of the image stack A 202 is image A4 214 which (due to the stacked arrangement) is substantially obscured by the image A1 208, the image A2 210 and the image A3 212. The next image in the stack configuration of the image stack A 202 is image A5 216 which (due to the stacked arrangement) is substantially obscured by the image A1 208, the image A2 210, the image A3 212 and the image A4 214. Given the stacked arrangement, any image below (or behind) another image in a stack will be substantially obscured by at least that image that is above (or on top). The image stack B 204 and the image stack C 306 can be similarly configured. For example, as shown in FIG. 2, image B1 218 is the graphical depiction for the digital media asset presently at the top of the image stack B 204, and image C1 220 is the graphical depiction for the digital media asset presently at the top of the image stack C 206.

The image stacks 202, 204 and 206 are user interactive in that a user can interact with the corresponding image stacks. Through user interaction, the user can transition through the various different graphical depictions for each of the digital media assets within the corresponding image stack. For example, if the user interacts with the image stack A 202 to cause the image A2 210 to appear at the top of the image stack A 202, the image A1 208 will have been hidden from the image stack A 202 or placed at the rear of the image stack A 202, at which point the image A1 208 would not then be obscuring any of the other images in the image stack A 202.

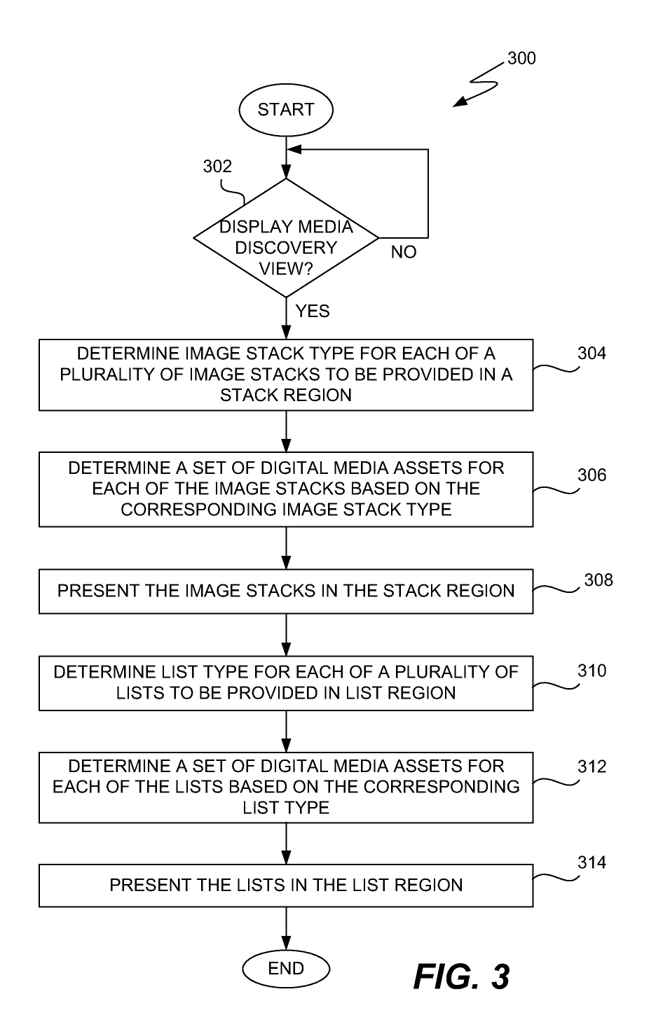

FIG. 3 is a flow diagram of an image stack and list presentation method 300 according to one embodiment. The image stack presentation and list method 300 can be performed by a computing device, such as a personal computing device.

The image stack presentation and list method 300 can begin with a decision 302 that can determine whether a media discovery view is to be displayed. Here, the computing device typically has a display device associated therewith, and the media discovery view can be associated with a graphical user interface that can be presented on the display device. The decision 302 determines whether the media discovery view is to be displayed. When the decision 302 determines that the media discovery view is not to be displayed at this time, the decision 302 can cause the image stack and list presentation method 300 to await the need to display the media discovery view.

Alternatively, when the decision 302 determines that the media discovery view should be displayed, an image stack type can be determined 304 for each of a plurality of image stacks to be provided in a stack region of the media discovery view. Next, a set of digital media assets for each of the image stacks can be determined 306 based on the corresponding image stack type. In other words, depending upon the particular image stack type, the digital media assets to be provided within a corresponding image stack will differ. Examples of various image stack types are discussed in more detail below. After the set of digital media assets for each of the image stacks has been determined 306, the image stacks can be presented 308 in the stack region of the media discovery view.

In addition, the image stack and list presentation method 300 can determine 310 a list type for each of a plurality of lists be provided in a list region of the media discovery view. Next, a set of digital media assets can be determined 312 for each of the lists based on the corresponding list type. In other words, depending upon the particular list type, the digital media assets to be provided within a corresponding list will differ. Examples of various list types are discussed in more detail below. After the set of digital media assets for each of the lists has been determined 312, the lists can be presented 314 in the list region of the media discovery view.

Following the presentation 314 of the lists, the image stack and list presentation method 300 is complete and can end.

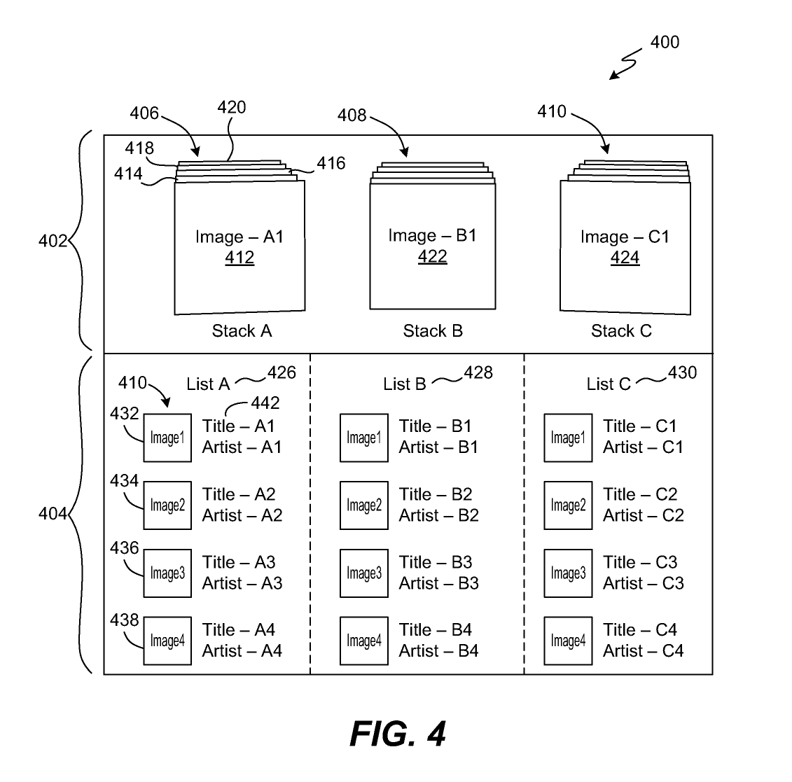

FIG. 4 is an illustration of a graphical user interface 400 according to another embodiment. The graphical user interface 400 can include a plurality of image stacks in a stack region 402, and can include a plurality of lists in a list region 404.

As illustrated in FIG. 4, the stack region 402 of the graphical user interface 400 can include image stack A 406, image stack B 408 and image stack C 410. Each of these image stacks 406, 408 and 410 contain a plurality of associated digital media assets which can each be presented in the graphical user interface 400 by a graphical depiction. With respect to the image stack A 406, graphical depictions for each of its associated digital media assets can be arranged in a stack configuration. For example, as shown in FIG. 4, image A1 412 is the graphical depiction for the digital media asset presently at the top of the image stack A 406. The next image in the stack configuration of the image stack A 406 is image A2 414 which (due to the stacked arrangement) is substantially obscured by the image A1 412. The next image in the stack configuration of the image stack A 406 is image A3 416 which (due to the stacked arrangement) is substantially obscured by the image A1 412 and the image A2 414. The next image in the stack configuration of the image stack A 406 is image A4 418 which (due to the stacked arrangement) is substantially obscured by the image A1 412, the image A2 414 and the image A3 416. The next image in the stack configuration of the image stack A 406 is image A5 420 which (due to the stacked arrangement) is substantially obscured by the image A1 412, the image A2 414, the image A3 416 and the image A4 418. Given the stacked arrangement, any image below (or behind) another image in a stack will be substantially obscured by at least that image that is above (or on top). The image stack B 408 and the image stack C 410 can be similarly configured. For example, as shown in FIG. 4, image B1 422 is the graphical depiction for the digital media asset presently at the top of the image stack B 408, and image C1 414 is the graphical depiction for the digital media asset presently at the top of the image stack C 410.

The image stacks 406, 408 and 410 are user interactive in that a user can interact with the corresponding image stacks. Through user interaction, the user can transition through the various different graphical depictions for each of the digital media assets within the corresponding image stack. For example, if the user interacts with the image stack A 406 to cause the image A2 414 to appear at the top of the image stack A 406, the image A1 412 will have been hidden from the image stack A 406 or placed at the rear of the image stack A 406, at which point the image A1 412 would not then be obscuring any of the other images in the image stack A 406.

As illustrated in FIG. 4, the lists region 404 of the graphical user interface 400 can include image list A 426, image list B 428 and image list C 430. Each of these image lists 426, 428 and 430 contain a plurality of associated digital media assets that are presented in the graphical user interface 400 by a graphical depiction. With respect to the image list A 424, graphical depictions for each of its associated digital media assets can be arranged in a list configuration. For example, as shown in FIG. 4, a first digital media asset A1 432 is the first digital media asset in the image list A 426, a second digital media asset A2 434 is the second digital media asset in the image list A 426, a third digital media asset A3 436 is the third digital media asset in the image list A 426, and a fourth digital media asset A4 438 is the fourth digital media asset in the image list A 426. For each of the digital media assets being listed in the image list A 426, the presentation thereof in the graphical user interface 400 can include an image representation 440 (e.g., image associated with the digital media asset, such as cover art, poster, etc.) and a textual representation 442. In the example provided in FIG. 4, the textual representation 442 can include a title and an artist for the associated digital media asset. Although the image list A 426 is shown in FIG. 4 as having four items, it should be understood that the image list A 426 can include more than four items. The image list A 426 can also permit scrolling of its list if the portion of the list region 404 cannot display all of the items in the image list A 426. The image list B 428 and the image list C 430 can be similarly constructed.

The image lists 426, 428 and 430 are user interactive in that a user can interact with the corresponding image lists. Through user interaction, the user can transition through and/or select the various different digital media assets within the corresponding list stack. For example, the user can interact with the image list A 426 to select any of the digital media assets therein.

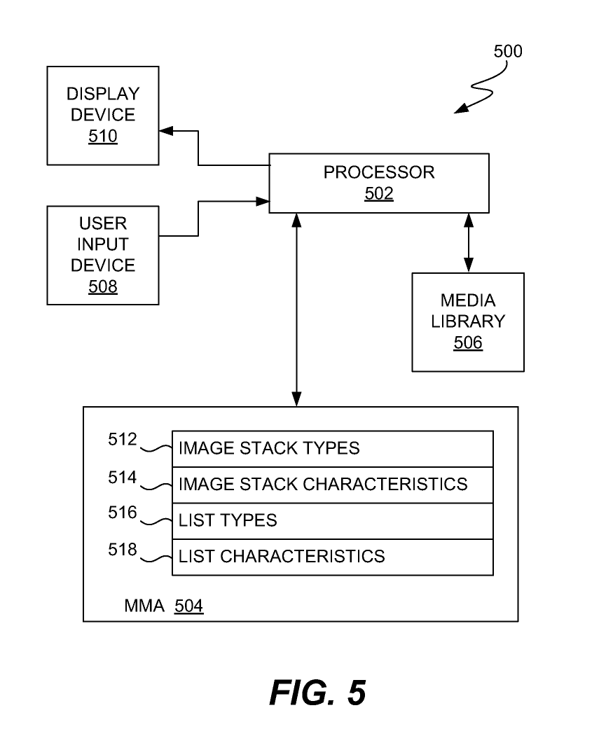

FIG. 5 is a block diagram of a computing apparatus 500 according to one embodiment. The computing apparatus 500 can, for example, be utilized to perform the image stack presentation method 100 illustrated in FIG. 1 or the image stack and list presentation method 300 illustrated in FIG. 3.

The computing apparatus 500 can include a processor 502 that provides program execution capabilities for the computing apparatus 500. The computing apparatus 500 can also include a media management application 504 and a media library 506. The media management application 504 can represent a computer program that can be executed by the processor 502 to provide me operations at the computing apparatus 500. For example, the media management application 504 can be used to display graphical user interfaces that allow users to browse and play digital media assets that can be stored in the media library 506. The computing apparatus 500 can also include a user input device 508, such as a pointing device, a keyboard, a touchscreen, etc., and a display device 510 that can display the graphical user interfaces. Still further, the media management application 504, or more generally the computing apparatus 500, can include user interface (UI) data that helps customize the graphical user interfaces that can be presented on the display device 510. As an example, as illustrated in FIG. 5, the data or configuration can include image stack types 512, image stack characteristics 514, list types 516 and list characteristics 518. The computing apparatus 500 can include one or more memory devices for data storage. For example, the MMA 504 and the media library 506 can be stored in a semiconductor memory and/or a disc storage memory.

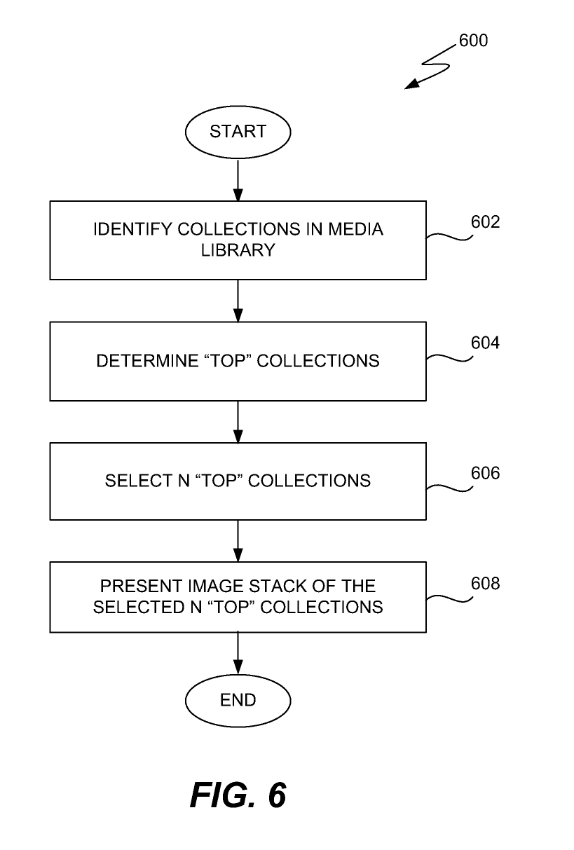

FIGS. 6-8 are flow diagrams of processes that can be used to produce and present image stacks of particular image stack types. These processes can be used for a particular image stack being determined and presented at blocks 106 and 108 of the image stack and list presentation method 100 of FIG. 1 or blocks 306 and 308 of the image stack and list presentation method 300 of FIG. 3.

FIG. 6 is a flow diagram of a top collections process 600 according to one embodiment. The top collections process 600 is used to produce an image stack associated with collections that are highly ranked or rated. The top collection associated with the top collections process represents an image stack type.

The top collections process 600 can initially identify 602 a plurality of collections in a media library (e.g., the media library 506). Next, the “top” collections from the identified collections can be determined 604. Those of the identified collections that are to be deemed “top” collections can be dependent upon various different criteria. For example, the “top” collections can be determined from the identified collections based on popularity, play count, ratings or other available criteria. Typically, the number of collections to be provided in the stack of “top” collections would be limited to a predetermined number. In this embodiment, the predetermined number is the integer N. Hence, after the “top” collections have been determined 604, the top collections process 600 can operates to select 606 N of the “top” collections. For example, the “top” collections that have been determined 604 would typically be sorted or ordered in accordance with the criteria associated with the “top” collections. After the “top” collections have been sorted or ordered, the N top most ones of the “top” collections can be selected 606. Thereafter, the image stack of the selected N “top” collections can be presented 608. Following the block 608, the top collections process 600 is complete and can end.

In one embodiment, the “top” collections from the identified collections can be determined 604 and selected 606 by the following operations. First, collections of digital media assets within the media library can be identified. Second, play counts for each of the identified collections are determined. Third, a predetermined number of the identified collections can be selected based on the determined play counts. Fourth, the selected identified collections for the at least one of the image stacks of the top collections type can be so denoted for subsequent presentation. In one particular embodiment, the play counts for each of the identified collections can be determined by (i) obtaining play counts for each of the digital media assets within a given one of the identified collections, and (ii) averaging the obtained play counts to produce the play count for the given one of the identified collections.

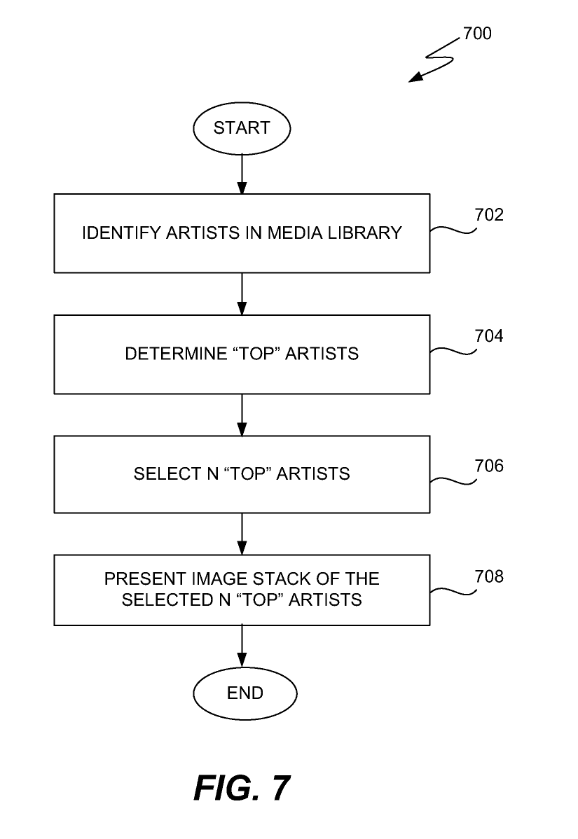

FIG. 7 is a flow diagram of a top artists process 700 according to one embodiment. The top artists process 700 is used to produce an image stack associated with artists that are highly ranked or rated. The top artists associated with the top artists process 700 represents an image stack type.

The top artists process 700 can initially identify 702 artists that are present in the media library (e.g. the media library 506). Next, “top” artists from the identified artists can be determined 704. Those of the identified artists that are to be deemed “top” artists can be dependent upon various different criteria. For example, the “top” artists can be determined from the identified artists based on popularity, play count, ratings or other available criteria. Typically, the number of artists to be provided in the stack of “top” artists would be limited to a predetermined number. In this embodiment, the predetermined number is the integer N. Hence, after the “top” artists have been determined 704, the top artists process 700 can operate to select 706 N of the “top” artists. For example, the “top” artists that have been determined 704 would typically be sorted or ordered in accordance with the criteria associated with the “top” artists. After the “top” artists have been sorted or ordered, the N top most ones of the “top” artists can be selected 706. Thereafter, the image stack of the selected N “top” artists can be presented 708. Following the block 708, the top artists process 700 is complete and can end.

In one embodiment, the “top” collections from the identified collections can be determined 704 and selected 706 by the following operations. First, artists of digital media assets within the media library can be identified. Second, play counts for each of the identified artists are determined. Third, a predetermined number of the identified artists can be selected based on the determined play counts. Fourth, the selected identified artists for the at least one of the image stacks of the top artists type can be so denoted for subsequent presentation. In one particular embodiment, the play counts for each of the identified artists can be determined by (i) obtaining play counts for each of the digital media assets of a given one of the identified artists, and (ii) accumulating the obtained play counts to produce the play count for the given one of the identified artists.

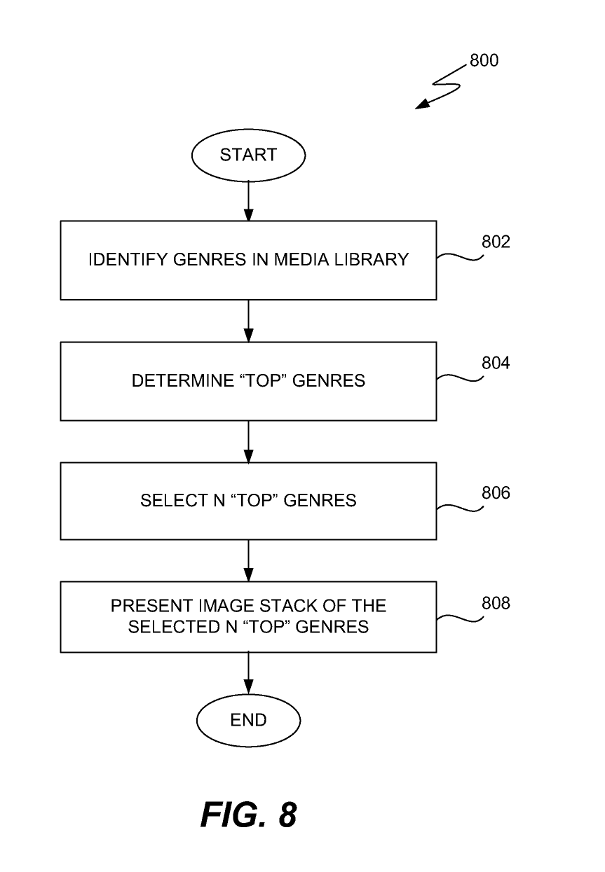

FIG. 8 is a flow diagram of a top genres process 800 according to one embodiment. The top genres process 800 is used to produce an image stack associated with genres that are highly ranked or rated. The top genres associated with the top genres process 800 represents an image stack type.

The top genres process 800 can initially identify 802 genres that are present in the media library (e.g. the media library 506). Next, “top” genres from the identified genres can be determined 804. Those of the identified genres that are to be deemed “top” genres can be dependent upon various different criteria. For example, the “top” genres can be determined from the identified genres based on popularity, play count, ratings or other available criteria. Typically, the number of genres to be provided in the stack of “top” genres would be limited to a predetermined number. In this embodiment, the predetermined number is the integer N. Hence, after the “top” genres have been determined 804, the top genres process 800 can operate to select 806 N of the “top” genres. For example, the “top” genres that have been determined 804 would typically be sorted or ordered in accordance with the criteria associated with the “top” genres. After the “top” genres have been sorted or ordered, the N top most ones of the “top” genres can be selected 806. Thereafter, the image stack of the selected N “top” genres can be presented 808. Following the block 808, the top genres process 800 is complete and can end.

Other types of image stacks include: a recently added type, recently played type, most played type, or top rated type.

In one embodiment, one of the images stacks to be used in a graphical user interface is a recently added type. Predetermined image stack characteristics for the recently added type can includes at least a predetermined number that represents a number of digital media assets to include in the image stack of the recently added type. In one particular embodiment, the determination of the set of digital media assets for the image stack of the recently added type can be determined by the following operations. First, digital media assets within the media library can be identified. Second, dates that each of the identified digital media assets were added to the media library can be obtained. Third, the predetermined number of the identified digital media assets can be selected based on the obtained dates added. Fourth, the selected identified digital media assets can be denoted as the set of digital media assets for the image stack of the recently added type can be so denoted for subsequent presentation. At least one of the selected identified digital media assets can be a collection of digital media assets.

In another embodiment, one of the images stacks to be used in a graphical user interface is a recently played type. Predetermined image stack characteristics for the recently played type can includes at least a predetermined number that represents a number of digital media assets to include in the image stack of the recently played type. In one particular embodiment, the determination of the set of digital media assets for the image stack of the recently played type can be determined by the following operations. First, digital media assets within the media library can be identified. Second, time last played for each of the identified digital media assets can be obtained. Third, the predetermined number of the identified digital media assets can be selected based on the obtained time last played. Fourth, the selected identified digital media assets can be denoted as the set of digital media assets for the image stack of the recently played type can be so denoted for subsequent presentation. The selected identified digital media assets can, for example, be songs, videos, podcasts, or e-books.

In another embodiment, one of the images stacks to be used in a graphical user interface is a most played type. Predetermined image stack characteristics for the most played type can includes at least a predetermined number that represents a number of digital media assets to include in the image stack of the most played type. In one particular embodiment, the determination of the set of digital media assets for the image stack of the most played type can be determined by the following operations. First, digital media assets within the media library can be identified. Second, play counts for each of the identified digital media assets can be obtained. Third, the predetermined number of the identified digital media assets can be selected based on the play counts. Fourth, the selected identified digital media assets can be denoted as the set of digital media assets for the image stack of the most played type can be so denoted for subsequent presentation. The selected identified digital media assets can, for example, be songs, videos, podcasts, or e-books.

In still another embodiment, one of the images stacks to be used in a graphical user interface is a top rated type. Predetermined image stack characteristics for the top rated type can includes at least a predetermined number that represents a number of digital media assets to include in the image stack of the top rated type. In one particular embodiment, the determination of the set of digital media assets for the image stack of the top rated type can be determined by the following operations. First, digital media assets within the media library can be identified. Second, ratings for each of the identified digital media assets can be obtained. Third, the predetermined number of the identified digital media assets can be selected based on the ratings. Fourth, the selected identified digital media assets can be denoted as the set of digital media assets for the image stack of the top rated type can be so denoted for subsequent presentation. The selected identified digital media assets can, for example, be songs, videos, podcasts, or e-books.

Other types of image stacks include: forgotten favorites, new to me, or top charts, or now playing. A forgotten favorites type image stack can include digital assets that have relatively high ratings or relatively high play counts but have not been played for a significant period of time (e.g., 3 month, 6 months, etc.). A new to me type image stack can include digital assets that are presented in one's media library but never played, and can be sorted based on date added. A top charts type image stack can include digital assets that are identified by top charts by an online media store. A now playing type image stack can include the digital asset now being played as well as digital assets that are queued for playing.

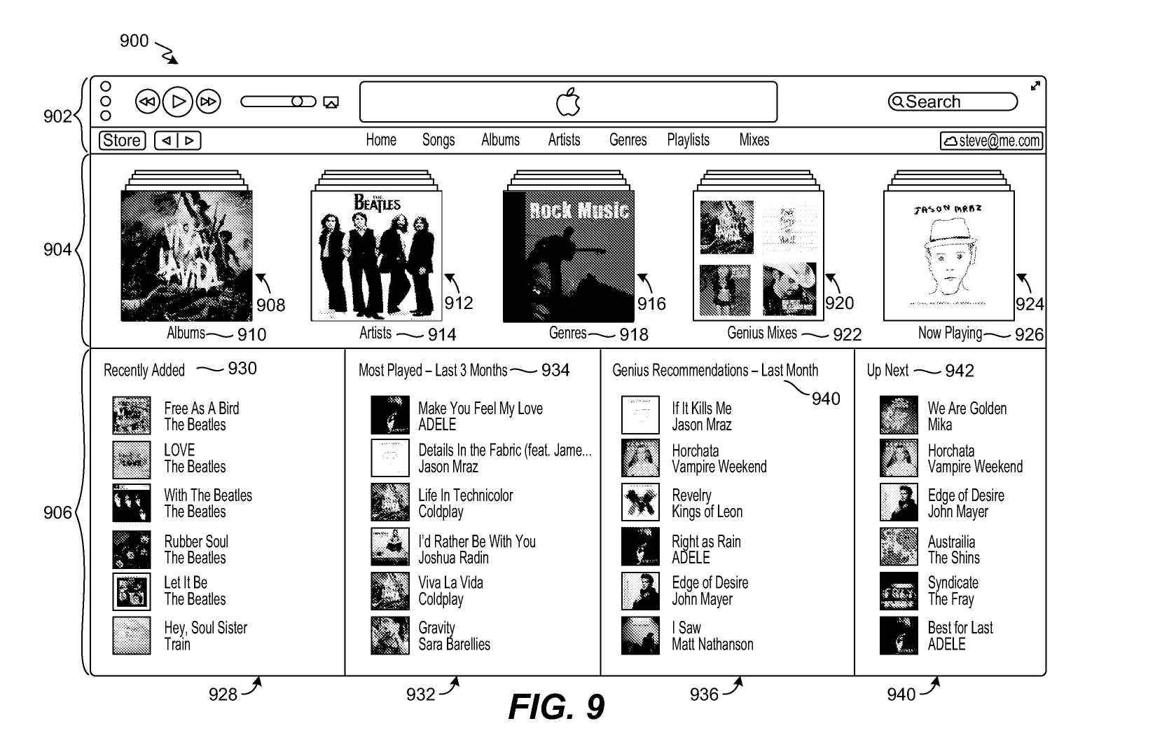

FIG. 9 is an illustration of a graphical user interface 900 according to another embodiment. The graphical user interface 900 can represent one implementation of the graphical user interface 400 illustrated in FIG. 4.

The graphical user interface 400 can include a plurality of user selectable controls in a toolbar-menu region 902, a plurality of image stacks in a stack region 904, and can include a plurality of lists in a list region 906.

As illustrated in FIG. 9, the toolbar-menu region 902 can include various user-selectable controls, including playback controls, navigation controls, login information, search box, and/or drop-down menus.

As also illustrated in FIG. 9, the stack region 904 of the graphical user interface 400 can include a plurality of image stacks. In particular, the stack region 904 includes: an album image stack 908 and an album identifier 910 provided proximate (e.g., adjacent) thereto, an artist image stack 912 and an artist identifier 914 provided proximate (e.g., adjacent) thereto, a genres image stack 916 and a genres identifier 918 provided proximate (e.g., adjacent) thereto, a genius mixes image stack 920 and a genius mixes identifier 922 provided proximate (e.g., adjacent) thereto, and a now playing stack 924 and a now playing identifier 926 provided proximate (e.g., adjacent) thereto.

Each of these image stacks 908, 912, 916, 920 and 924 contain a plurality of associated digital media assets which can each be presented as a graphical depiction in the stack region 904 of the graphical user interface 900. Each of the image stacks provides a graphical depiction for each of its associated digital media assets arranged in a stack configuration.

The image stacks 908, 912, 916, 920 and 924 are user interactive in that a user can interact with the corresponding image stacks. Through user interaction, the user can transition through the various different graphical depictions for each of the digital media assets within the corresponding image stack. For example, each of the image stacks displayed in the stack region 904 are capable of receiving user input to (i) play a digital media asset corresponding to the image displayed at the top of the associated image stack, or (ii) transition to present another one of the images at the top of the associated image stack.

As also illustrated in FIG. 9, the list region 906 of the graphical user interface 900 can include a plurality of image lists. In particular, the list region 906 includes: a recently added list 928 and a recently added list identifier 930 provided proximate (e.g., adjacent) thereto, a most played list 932 and a most played identifier 934 provided proximate (e.g., adjacent) thereto, a genius recommendations list 936 and a genius recommendations identifier 938 provided proximate (e.g., adjacent) thereto, and a up next list 940 and an up next identifier 942 provided proximate (e.g., adjacent) thereto.

For each of the digital media assets being listed in the recently added list 928, the presentation thereof in the list region 906 of the graphical user interface 900 can include a small image representation (e.g., image associated with the digital media asset, such as cover art, poster, etc.) and a textual information. In the example provided in FIG. 9, the textual information for the digital media assets in the recently added list 928 can include a title and an artist for the associated digital media asset. Although the recently added list 928 is shown in FIG. 9 as having six items, it should be understood that the recently added list 928 can include more than six items. In the event that the recently added list 928 includes more items than can be initially displayed, the recently added list 928 can also permit scrolling of its list. The most played list 932, the genius recommendations list 936 and the up next list 940 can be similarly constructed.

The image lists illustrated in the list region 906 are also user interactive in that a user can interact with the corresponding image lists. Through user interaction, the user can transition through the various different graphical depictions for each of the digital media assets within the corresponding image stack. For example, each of the lists displayed in the list region 906 are capable of receiving user input to (i) play a digital media asset corresponding to the image displayed for one of the digital media assets within the associated image list, or (ii) scroll the associated image list to present one or more other images that corresponding to other digital media assets of the associated image list.

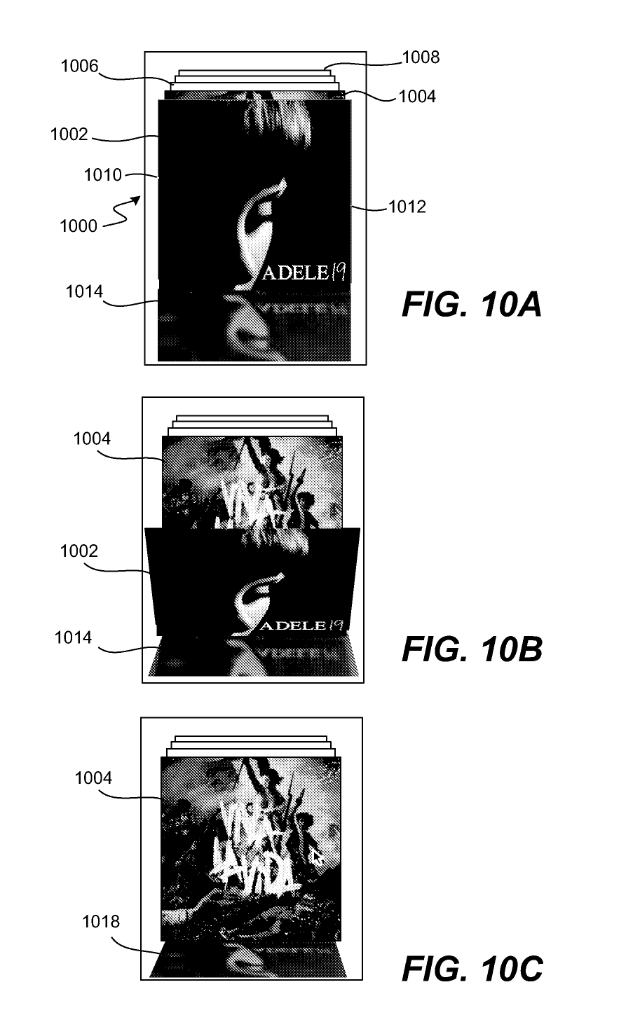

FIGS. 10A-10C illustrate navigation and utilization of an exemplary image stack 1000 according to one embodiment. The exemplary image stack 1000 includes a plurality of image representations 1002-1008 that represent distinct digital media assets grouped within the exemplary image stack 1000. The image representation 1002 represents the digital media asset at the top of the exemplary image stack 1000 as illustrated in FIG. 10A. As shown in FIG. 10A, a user can initiate playing of the digital media asset corresponding to the image representation 1002 by selecting a graphical play control 1010 that can be presented over the image representation 1002. A cursor 1012 can also be utilized to designate selection or manipulation of the image representation 1002. For example, in one embodiment, when the cursor 1012 is manipulated over the image representation 1002, the graphical play control 1010 can be presented over the image representation 1002. Thereafter, upon selection of the presented graphical play control 1010, the user is able to request playback of the digital media asset corresponding to the image representation 1002, which in this illustration is at the top of the image stack 1000.

Additionally, is to be noted that the exemplary image stack 1000 can be presented visually primarily by the image representation at the top of the stack, which is the image representation 1002 in FIG. 10A. However, as illustrated in FIG. 10A, the various other image representations 1004-1008 that are provided in the exemplary image stack 1000 are presently but substantially obscured by at least the image representation 1002 while provided at the top of the exemplary image stack 1000. Additionally, a reflected image representation 1013 can be provided adjacent and below the image representation 1002. As shown in FIG. 10A, the reflected image representation 1013 is a reflection of the image representation 1002. In one implementation, the reflected image representation 1013 can be compressed or chopped such that its vertical height is substantially less than the vertical height of the image representation 1002.

In FIG. 10B, the exemplary image stack 1000 is interacted with by a user to initiate a transition such that the image representation at the top of the exemplary image stack 1000 changes. In this regard, a user can utilize the cursor 1012 or a user's finger to signal the computing device that the image representation 1002 at the top of the exemplary image stack 1000 should be moved off the top of the exemplary image stack 1000 so that a next image representation (e.g., the image representation 1004) is exposed. As shown in FIG. 10B, the transition from the image representation 1002 to the image representation 1004 has been partially performed. Here, the transition is performed in an animated manner such that the user perceives the flipping of the image representation 1002 downward and the presentation of the image representation 1004 at the top of the image stack 1000. Additionally, as shown in FIG. 10B, the image representation 1002 is still presented as a reflected image representation 1016 and is placed adjacent and below the image representation 1004.

FIG. 10C illustrates completion of the transition from the image representation 1002 to the image representation 1004. Additionally, a bottom image representation 1018 can be provided adjacent and below the image representation 1004. As shown in FIG. 10C, the bottom image representation 1018 is a reflection of the image representation 1002, which can here serve to indicate that the image representation 1002 has been completely flipped down. Alternatively, the bottom image representation 1018 could be a reflection of the image representation 1004, which is currently at the top of the image stack 1000.

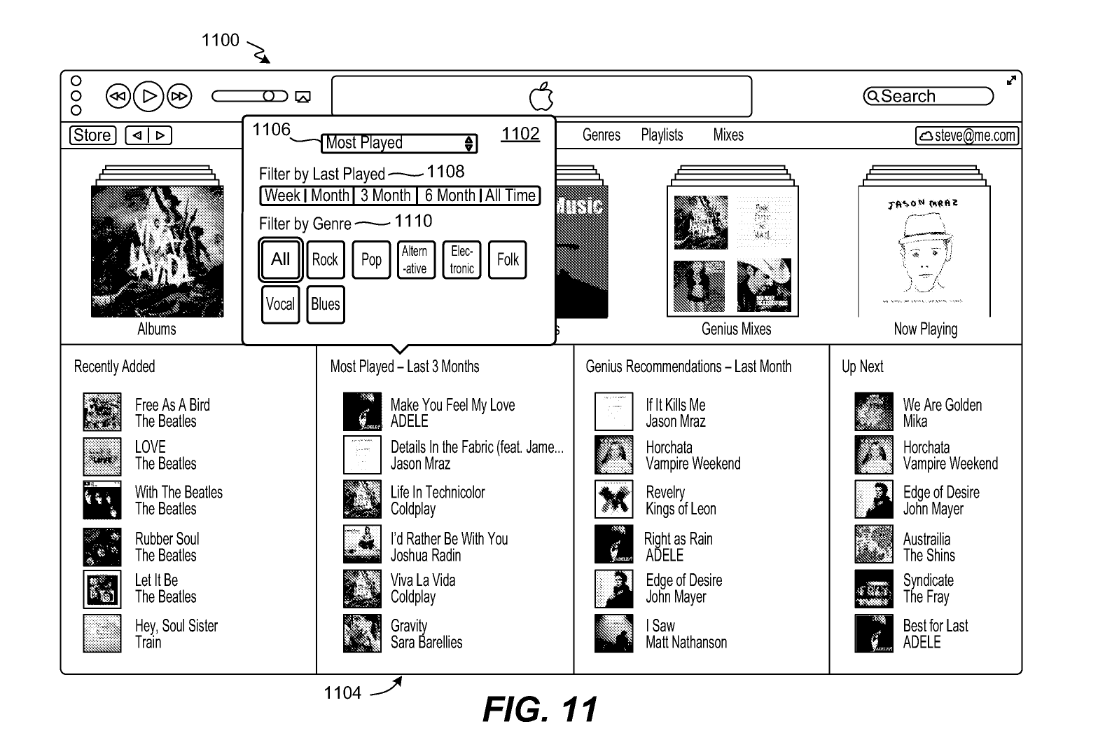

FIG. 11 is an illustration of a graphical user interface 1100 according to another embodiment. The graphical user interface 1100 is similar to the graphical user interface 900 illustrated in FIG. 9. However, in FIG. 11, a configuration interface 1102 can be presented over a portion of the graphical user interface 1100. As illustrated in FIG. 11, the configuration interface 1102 corresponds to an image list 1104, which is same or similar to the most played image list 932 illustrated in FIG. 9. The configuration interface 1102 is thus presented on the graphical user interface 1100 adjacent or proximate to the image list 1104. In one embodiment, the configuration interface 1102 is can have a partially translucent background.

The configuration interface 1102, in this example, includes a list type selector 1106 that currently indicates that the configuration interface 1102 corresponds to the most played image list 1104. The configuration interface 1102 can also includes a first filtering designator 1108 that indicates that the filtering can be provided in accordance with the last played criteria, such that the digital media assets within the most played image list 1104 are sorted such that the digital media assets that were last played are towards the top of the most played image list 1104. In this regard, the configuration interface 1102 can allow a time period over which the last played evaluation occurs. For an example, the configuration interface 1102 supports the time periods of: one week, one month, three months, six months, or for all time, which the last played evaluation can occur. Still further, the configuration interface 1002 can also include a second filter designator 1010 that indicates that filtering can be provided in accordance with at least one specified genre. For an example, the configuration interface 1102 supports the genres of: all genres, rock, alternative, pop, electronic, folk, vocal or blues.

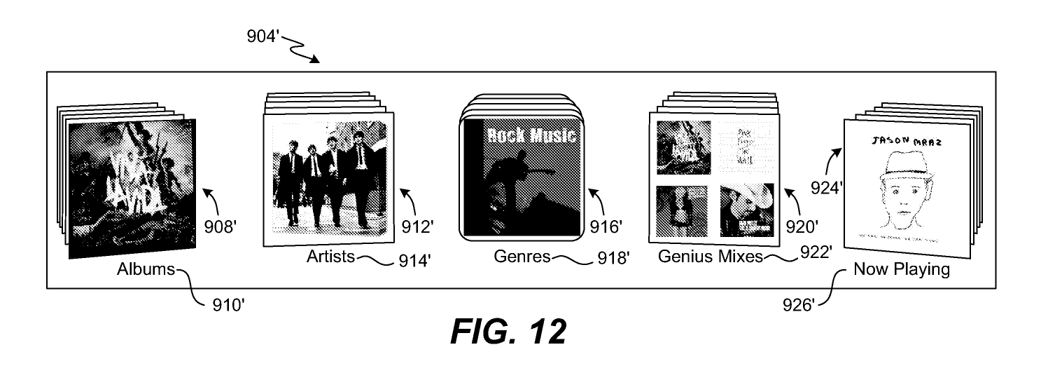

FIG. 12 is an illustration of a stack region 904′ according to an alternative embodiment. The stack region 904′ represents an alternative arrangement for the stack region 904 illustrated in FIG. 9. In particular, the stack region 904′ includes the same image stacks and operates the same as does the stack region 904. More specifically, the image stacks in the stack region 904′ include an album image stack 908′ and an album identifier 910′ provided proximate thereto, an artist image stack 912′ and an artist identifier 914′ provided proximate thereto, a genres image stack 916′ and a genres identifier 918′ provided proximate thereto, a genius mixes image stack 920′ and a genius mixes identifier 922′ provided proximate thereto, and a now playing stack 924′ and a now playing identifier 926′ provided proximate thereto. However, the image stacks in the stack region 904′ have been provided in an arced horizontal arrangement, instead of a straight horizontal arrangement. As a result, the image stacks are presented in the stack region 904′ with more of a three-dimensional appearance. More specifically, the image stacks are provided along a virtual arc and are thus appropriately skewed. The album image stack 912′ and the album identifier 910′ as well as the now playing stack 924′ and the now playing identifier 926′ are skewed the most since they are placed on the ends of the stack region 904. The artist image stack 912′ and the artist identifier 914′ as well as the genius mixes image stack 920′ and the genius mixes identifier 922′ are moderately skewed. The genres image stack 916′ and the genres identifier 918′ are at the center of the stack region 904 and thus need not be skewed in the arced horizontal arrangement.

In view of the foregoing, it will readily be known that an electronic device provided in accordance with one or more embodiments can, for example, be a computing device (e.g., personal computing device). Examples of electronic devices and/or computing devices include a personal computer, a mobile phone (e.g., cellular phone, smart phone), a personal digital assistant (PDA), a media player (e.g., music, videos, games, images), a media storage device, a camera, and/or the like. An electronic device may also be a multi-functional device that combines two or more of these device functionalities into a single device. A portable electronic device may support various types of network communications.

Digital assets (e.g., digital media items) can, for example pertain to video items (e.g., video files or movies), audio items (e.g., audio files or audio tracks, such as for songs, musical albums, podcasts or audiobooks), image items (e.g., photos), or application (e.g., application programs).

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion. Some embodiments may be implemented by software, but can also be implemented in hardware or a combination of hardware and software. Some implementations may be embodied as computer readable code on a tangible computer readable medium. The tangible computer readable medium is any data storage device that can store data which can thereafter be read by a computer system. Examples of tangible computer readable medium include read-only memory, random-access memory, CD-ROMs, DVDs, magnetic tape, and optical data storage devices.

The various aspects, features, embodiments or implementations of the invention described above can be used alone or in various combinations.

Although only a few embodiments of the invention have been described, it should be understood that the invention may be embodied in many other specific forms without departing from the spirit or the scope of the present invention. By way of example, the steps associated with the methods of the invention may vary widely. Steps may be added, removed, altered, combined, and reordered without departing from the spirit of the scope of the invention. Similarly, while operations are depicted in the drawings in a particular order, this should not be understood as requiring that such operations be performed in the particular order shown or in sequential order, or that all illustrated operations be performed, to achieve desirable results.

While this specification contains many specifics, these should not be construed as limitations on the scope of the disclosure or of what may be claimed, but rather as descriptions of features specific to particular embodiment of the disclosure. Certain features that are described in the context of separate embodiments can also be implemented in combination. Conversely, various features that are described in the context of a single embodiment can also be implemented in multiple embodiments separately or in any suitable subcombination. Moreover, although features may be described above as acting in certain combinations, one or more features from a claimed combination can in some cases be excised from the combination, and the claimed combination may be directed to a subcombination or variation of a subcombination.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for discovering digital media assets from a media library storing a plurality of digital media assets, the method comprising:
determining, using at least one computing device, an image stack type for each of a plurality of image stacks to be provided in a stack region of a graphical user interface presented on a display device associated with the computing device;
determining, using the at least one computing device, a set of digital media assets for each of the image stacks based on the corresponding image stack type, the digital media assets in each of the sets of digital media assets being selected from the digital media assets in the media library; and
displaying the graphical user interface including the image stacks on the display device.

2. A method as recited in claim 1, wherein each of the image stack types have predetermined image stack characteristics associated therewith, and
wherein the determining of the set of digital media assets for each of the image stacks uses the predetermined image stack characteristics corresponding thereto.

3. A method as recited in claim 2, wherein at least one of the image stack types for the image stacks of the graphical user interface pertains to a top collections type, and the predetermined image stack characteristics for the top collections type includes at least a predetermined number of digital media assets to include in the image stack of the top collections type.

4. A method as recited in claim 3, wherein the determining of the set of digital media assets for the at least one of the image stacks of the top collections type comprises:
identifying collections of digital media assets within the media library;
determining play counts for each of the identified collections;
selecting the predetermined number of the identified collections based on the determined play counts; and
denoting the selected identified collections for the at least one of the image stacks of the top collections type.

5. A method as recited in claim 4, wherein the determining of the play counts for each of the identified collections comprises:
obtaining play counts for each of the digital media assets within a given one of the identified collections; and
averaging the obtained play counts to produce the play count for the given one of the identified collections.

6. A method as recited in claim 2, wherein at least one of the image stack types for the image stacks of the graphical user interface pertains to a top artists type, and the predetermined image stack characteristics for the top artists type includes at least a predetermined number of digital media assets to include in the image stack of the top artists type.

7. A method as recited in claim 6, wherein the determining of the set of digital media assets for the at least one of the image stacks of the top artists type comprises:
identifying artists of digital media assets within the media library;
determining play counts for each of the identified artists;
selecting the predetermined number of the identified artists based on the determined play counts; and
denoting the selected identified artists for the at least one of the image stacks of the top artists type.

8. A method as recited in claim 7, wherein the determining of the play counts for each of the identified artists comprises:
obtaining play counts for each of the digital media assets of a given one of the identified artists; and
accumulating the obtained play counts to produce the play count for the given one of the identified artists.

9. A method as recited in claim 2, wherein at least one of the image stack types for the image stacks of the graphical user interface pertains to a top genre type, and the predetermined image stack characteristics for the top genre type includes at least a predetermined number of digital media assets to include in the image stack of the top genre type.

10. A method as recited in claim 9, wherein the determining of the set of digital media assets for the at least one of the image stacks of the top genre type comprises:
identifying genres of digital media assets within the media library;
determining play counts for each of the identified genres;
selecting the predetermined number of the identified genres based on the determined play counts; and
denoting the selected identified genres for the at least one of the image stacks of the top genre type.

11. A method as recited in claim 10, wherein the determining of the play counts for each of the identified artists comprises:
obtaining play counts for each of the digital media assets of a given one of the identified genres; and
accumulating the obtained play counts to produce the play count for the given one of the identified genres.

12. A method as recited in claim 2, wherein at least one of the image stack types for the image stacks of the graphical user interface includes at least a recently added type, and the predetermined image stack characteristics for the recently added type includes at least a predetermined number representing a number of digital media assets to include in the image stack of the recently added type.

13. A method as recited in claim 12, wherein the determining of the set of digital media assets for the at least one of the image stacks of the recently added type comprises:
identifying digital media assets within the media library;
obtaining dates added to the media library for each of the identified digital media assets;
selecting the predetermined number of the identified digital media assets based on the obtained dates added; and
denoting the selected identified digital media assets as the set of digital media assets for the at least one of the image stacks of the recently added type.

14. A method as recited in claim 13, wherein at least one of the identified digital media assets is a collection of digital media assets.

15. A method as recited in claim 2, wherein at least one of the image stack types for the image stacks of the graphical user interface includes at least a recently played type, and the predetermined image stack characteristics for the recently played type includes at least a predetermined number representing a number of digital media assets to include in the image stack of the recently played type.

16. A method as recited in claim 15, wherein the determining of the set of digital media assets for the at least one of the image stacks of the recently played type comprises:
identifying digital media assets within the media library;
obtaining time last played for each of the identified digital media assets;
selecting the predetermined number of the identified digital media assets based on the obtained time last played; and
denoting the selected identified digital media assets as the set of digital media assets for the at least one of the image stacks of the recently played type.

17. A method as recited in claim 2, wherein at least one of the image stack types for the image stacks of the graphical user interface includes at least a most played type, and the predetermined image stack characteristics for the most played type includes at least a predetermined number representing a number of digital media assets to include in the image stack of the most played type.

18. A method as recited in claim 17, wherein the determining of the set of digital media assets for the at least one of the image stacks of the most played type comprises:
identifying digital media assets within the media library;
determining play counts for each of the identified digital media assets;
selecting the predetermined number of the identified digital media assets based on the play counts; and
denoting the selected identified digital media assets as the set of digital media assets for the at least one of the image stacks of the most played type.

19. A method as recited in claim 18, wherein the identified digital media assets are songs.

20. A method as recited in claim 2, wherein at least one of the image stack types for the image stacks of the graphical user interface includes at least a top rated type, and the predetermined image stack characteristics for the top rated type includes at least a predetermined number representing a number of digital media assets to include in the image stack of the top rated type.

21. A method as recited in claim 20, wherein the determining of the set of digital media assets for the at least one of the image stacks of the top rated type comprises:
identifying digital media assets within the media library;
obtaining ratings for each of the identified digital media assets;
selecting the predetermined number of the identified digital media assets based on the ratings; and
denoting the selected identified digital media assets as the set of digital media assets for the at least one of the image stacks of the top rated type.

22. A method as recited in claim 21, wherein the identified digital media assets are songs.

23. A method as recited in claim 1, wherein the media library is stored at the computing device, and wherein the digital media assets in the media library are available for use by the computing device or the user thereof.

24. A method as recited in claim 1, wherein the displaying of the graphical user interface presents the image stacks on the display device in at least one row.

25. A method as recited in claim 1, wherein the method comprises:
determining, using the at least one computing device, a list type for each of a plurality of lists to be provided in a list region of a graphical user interface presented on the display device associated with the computing device; and
determining, using the at least one computing device, a set of digital media assets for each of the lists based on the corresponding list type, the digital media assets in each of the sets of digital media assets being selected from the digital media assets in the media library.

26. A method as recited in claim 1, wherein the displaying of the graphical user interface comprises concurrently display the image stacks and the lists on the display device.

27. A method as recited in claim 1,
wherein the displaying of the image stacks displays a plurality of images in a stacked arrangement,
wherein a top one of the images in each of the image stacks is visually displayed substantially over the other of the images in the image stack, and
wherein the method comprises:
altering the arrangement of the images within at least one of the image stacks such that a different one of the images in the image stack becomes the top image in response to user input associated with the image stack.

28. A non-transitory computer readable storage medium including at least computer program code for discovering digital media assets from a media library storing a plurality of digital media assets, the computer readable storage medium comprising:
computer program code for determining, using at least one computing device, an image stack type for each of a plurality of image stacks to be provided in a stack region of a graphical user interface presented on a display device associated with the computing device;
computer program code for determining, using the at least one computing device, a set of digital media assets for each of the image stacks based on the corresponding image stack type, the digital media assets in each of the sets of digital media assets being selected from the digital media assets in the media library; and
computer program code for displaying the graphical user interface including the image stacks on the display device.

29. A graphical user interface for display of a display device associated with a computing device, the graphical user interface comprising:
at least a stack region displayed on the display device, the stack region including a plurality of image stacks,
each of the image stacks including a set of image representations for each of a plurality of digital media assets, each of the digital media assets associated with each of the image stacks being selected from a media library resident on the computing device based on a corresponding image stack type, and
each of the images stacks are displayed on the display device in a stacked arrangement wherein a top one of the images in each of the image stacks is visually displayed substantially over each of the other of the images in the image stack, and each of the stacks are user-interactive such that a user input over or proximate to the stack permits a user to transition the images in the image stack such that a different one of the images becomes the top one of the images.

30. A graphical user interface as recited in claim 29, wherein, when the images in the image stack are transitioned in a first direction, a prior top image is transitioned downward and forward, and the image behind the prior top image is moved forward to become a next top image.

31. A graphical user interface as recited in claim 30, wherein after the transition, a reflected version of the prior top image is displayed adjacent the next top image, visually representing that the prior top image has been moved off the top of the image stack.

32. A graphical user interface as recited in claim 29, wherein the graphical user interface comprises:
at least a list region displayed on the display device, the list region including a plurality of lists.

33. A graphical user interface as recited in claim 32, wherein each of the lists has a list type that is associated with at least a list criterion used to determine the corresponding set of digital media assets from the media library that are to be included in the corresponding list.

34. A graphical user interface as recited in claim 32, wherein, on user request, a configuration interface can be presented over the graphical user interface, the configuration interface permits a user to configure a list within the list region.

34. A graphical user interface as recited in claim 32, wherein, on user request, a configuration interface can be presented over the graphical user interface, the configuration interface permits a user to configure a list within the list region by setting at least one of a list type, and a least one filter for sorting the list be displayed in the list region.

35. A graphical user interface as recited in claim 34, wherein the least one filter is chosen from at least (i) a time period filter and (ii) a genre selection.

36. A graphical user interface as recited in claim 29, wherein the image stacks in the stack region are displayed in a horizontal arrangement.

37. A graphical user interface as recited in claim 29, wherein the image stacks in the stack region are displayed in an arced arrangement, with certain of the image stacks be skewed to follow the arced arrangement.
